(19) United States
(12) Patent Application Publication
(10) Pub. No.: US 2012/0092087 A1
(43) Pub. Date: Apr. 19, 2012

(54) NOISE REDUCTION DEVICE FOR PORT OF DSL FILTER AND METHOD THEREOF

(75) Inventor: Wen Chung LIU, Kaohsiung City (TW)

(73) Assignee: ARCHICORE ELECTRONICS CO., LTD., KAOHSIUNG CITY (TW)

(21) Appl. No.: 12/905,155

(22) Filed: Oct. 15, 2010

(51) Int. Cl. H04B 3/28

(52) U.S. Cl. 333/12

(57) ABSTRACT

A noise reduction device for ports of DSL filters and a method thereof are revealed. A plurality of signal transmission line sets is arranged at the ports of a DSL filter. A first cross part is formed between the first signal transmission line and the second signal transmission line of the first signal transmission line set. Before the first cross part, the first signal transmission line of the second signal transmission line set is adjacent to the second signal transmission line of the first signal transmission line set while after the first cross part, the first signal transmission line of the second signal transmission line set is adjacent to the first signal transmission line of the first signal transmission line set. Thus the noises induced by interference between two adjacent signal transmission lines cancel each other out. Therefore, no interference noise occurs between two adjacent signal transmission lines.

### BACKGROUND OF THE INVENTION

1. Fields of the Invention

The present invention relates to a noise reduction device for ports of DSL filters and a method thereof, especially to a noise reduction device for ports of DSL filters and a method thereof by which no interference noise occurs between two adjacent signal transmission lines when signals transmitted are output. Thus the device has a higher practical value while in use.

2. Descriptions of Related Art

The development of modern technology leads to the prosperous development of computer network. Internet has become an essential part in our daily lives. One of the most ways that people access internet connections, DSL (Digital Subscriber Line) is a modulation/demodulation technology that uses ordinary telephone wiring to deliver fast digital data transmission and network service while at the same time providing POTS (Plain Old Telephone Services).

DSL is constructed based on standard copper pair of telephone facilities available now, It does this by utilizing frequencies that are not used by a voice telephone call. Thus DSL deliver a high-speed, downstream channel to subscribers and a lower-speed, upstream channel to the network without affecting the analog telephone service used.

In use, signals are filtered by filters and the filtered signals are sent to corresponding electronic devices by ports. Refer to FIG. 4, a port 2 of the DSL filter mainly includes a circuit board connection area 21 and a connection end 22. The circuit board connection area 21 and the connection end 22 are arranged perpendicular to each other. Vertical signal transmission lines 23 are disposed and connected between the circuit board connection area 21 and the connection end 22. The circuit board connection area 21 is soldered and fixed on a motherboard and the connection end 22 is used to connect with electronic devices. At the port 2, the DSL signals are transmitted by a plurality of sets of signal transmission lines 23 in a pair. The signals transmitted by two signal transmission lines 23 of the same set have a phase difference of 180 degrees.

However, during the signal transmission process of DSL, a problem occurs, Generally, signal transmission lines between ports of DSL filter are arranged closely to each other so that interference occurs between two adjacent transmission lines respectively of two different signal transmission line sets during signal transmission processes. Noise in the signals transmitted is increased and this deteriorates DSL transmission quality.

Thus there is a need to provide a noise reduction device for ports of DSL filters and a method thereof that overcome above shortcomings and has a higher practical value.

### SUMMARY OF THE INVENTION

Therefore it is a primary object of the present invention to provide a noise reduction device for ports of DSL filters and a method thereof A plurality of signal transmission line sets is disposed on the ports of a DSL filter. Between two adjacent signal transmission line sets, a first cross part is formed at an input end of the first signal transmission line and the second signal transmission line of the first signal transmission line set. Before the first cross part, the first signal transmission line of the second signal transmission line set is adjacent to the second signal transmission line of the first signal transmission line set. Yet after the first cross part, the first signal transmission line of the second signal transmission line set is adjacent to the first signal transmission line of the first signal transmission line set. Thus the noises of the first signal transmission line of the second signal transmission line set induced by interference between the first signal transmission line of the second signal transmission line set and the first/second signal transmission line of the first signal transmission line set cancel each other out. Thereby during output of the signals transmitted by the port, noises induced by the interference between the two adjacent signal transmission lines are eliminated. Thus the device has a higher practical value in use.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment according to the present invention;

FIG. 2 is a schematic diagram of an embodiment according to the present invention;

FIG. 3 is a schematic drawing showing an embodiment in application according to the present invention;

FIG. 4 is a perspective view of a prior art.

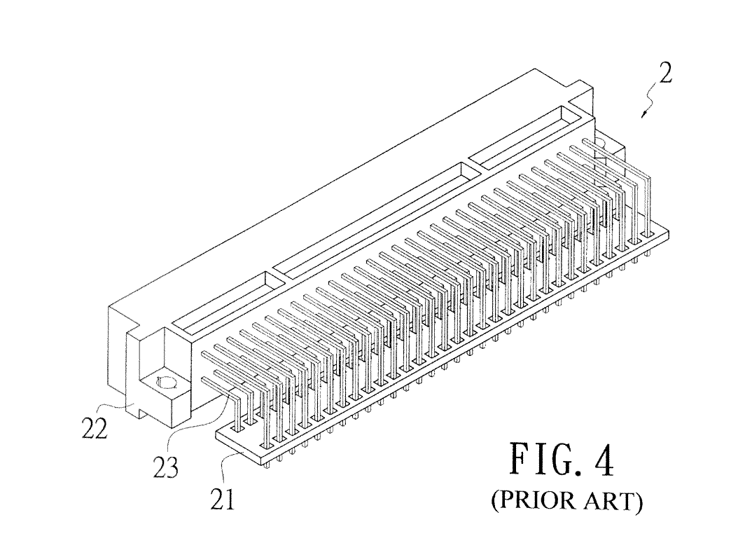

### DETAILED DESCRIPTION OF THE PREFERRED EMBODIMENT

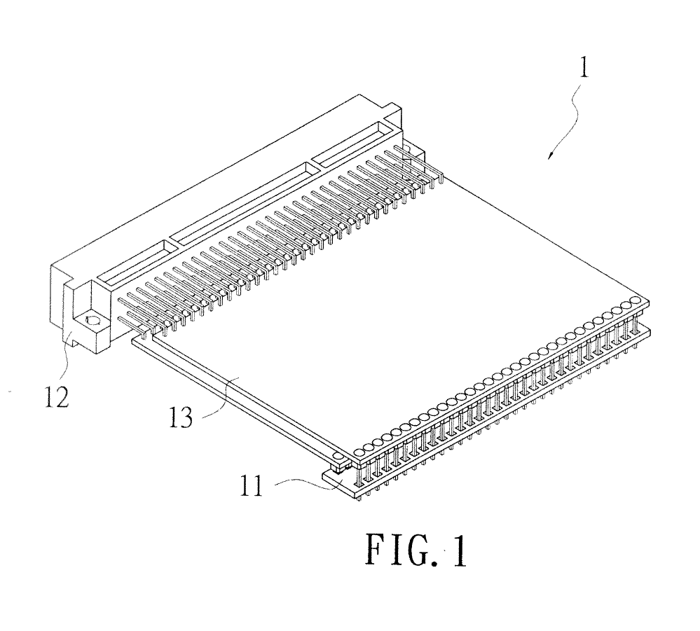

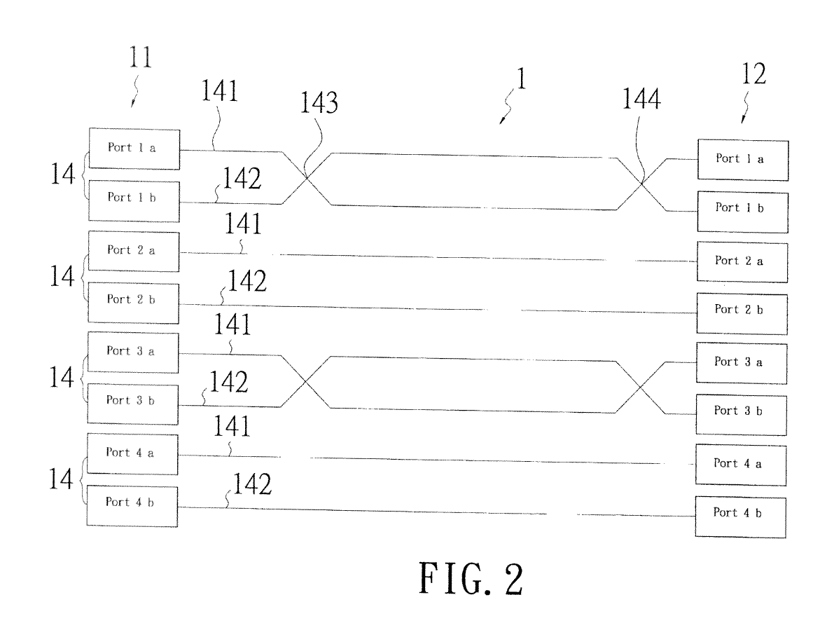

Refer to FIG. 1 and FIG. 2, in a DSL filter port 1, a circuit board 13 is disposed between a circuit board connection area 11 arranged vertically and a connection end 12. There is a plurality of signal transmission line sets 14 arranged on the circuit board 13 of the port 1 or inside the DSL filter and each signal transmission line set 14 is formed by a first signal transmission line 141 and a second signal transmission line 142. The phase difference between signals transmitted by the first signal transmission line 141 and the second signal transmission line 142 is 180 degrees.

Between two adjacent signal transmission line sets 14, the first signal transmission line 141 and the second signal transmission line 142 of the first signal transmission line set 14 cross each other to form a first cross part 143. Before the first cross part 143, the second signal transmission line 142 of the first signal transmission line set 14 is beside the first signal transmission line 141 of the second signal transmission line set 14. After the first cross part 143, the lines change into that the first signal transmission line 141 of the first signal transmission line set 14 is adjacent and closer to the first signal transmission line 141 of the second signal transmission line set 14. In order to make the first signal transmission line 141 and the second signal transmission line 142 of each signal transmission line set 14 at the circuit board connection area 11 and the connection end 12 arrange in the same order, at output ends, the first signal transmission line 141 and the second signal transmission line 142 of the first signal transmission line set 14 cross each other to form a second cross part 144. Thus after passing the second cross part 144, the first signal transmission line 141 of the second signal transmission line set 14 is changed to become closer to the second signal transmission line 142 of the first signal transmission line set 14.

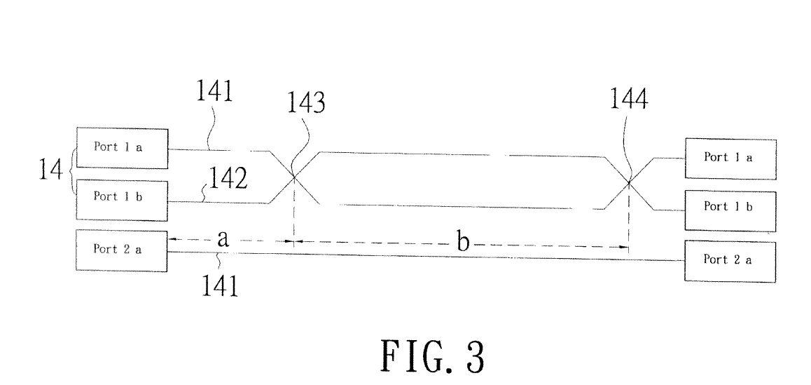

Also refer to FIG. 3, while in use, during signal transmission processes between the two adjacent signal transmission line sets 14 in the port 1 of the present invention, an interference occurs between the first signal transmission line 141 of the second signal transmission line set 14 and the second signal transmission line 142 of the first signal transmission line set 14 that are arranged adjacent to each other. A noise signal (label a in FIG. 3) from the second signal transmission line 142 of the first signal transmission line set 14 is introduced into the first signal transmission line 141 of the second signal transmission line set 14. After the first cross part 143 of the first signal transmission line set 14, the first signal transmission line 141 of the first signal transmission line set 14 is changed to be adjacent to the first signal transmission line 141 of the second signal transmission line set 14 so that an interference occurs between the first signal transmission line 141 of the second signal transmission line set 14 and the first signal transmission line 141 of the first signal transmission line set 14. Thus a noise signal (label b in FIG. 3) generated by the first signal transmission line 141 of the first signal transmission line set 14 is added to the first signal transmission line 141 of the second signal transmission line set 14. Now the first signal transmission line 141 of the second signal transmission line set 14 includes noises from the first signal transmission line 141 and the second signal transmission line 142 of the first signal transmission line set 14 at the same time. Because the signals transmitted by the first signal transmission line 141 and the second signal transmission line 142 of the first signal transmission line set 14 have a phase difference of 180 degrees, the two noises on the first signal transmission line 141 of the second signal transmission line set 14 cancel each other out and disappear. Thus signals output from the output end have no noise interference.

In summary, compared with the structure available now, the present invention includes the first cross part before which the first signal transmission line of the second transmission line set is adjacent to the second signal transmission line of the first transmission line set. Yet after the first cross part, the first signal transmission line of the second transmission line set is adjacent to the first signal transmission line of the first transmission line set. Thus the noises induced by interference between the adjacent first signal transmission line of the second signal transmission line set and the first signal transmission line/the second signal transmission line of the first signal transmission line set cancel each other out. Therefore, there is no interference noises between two adjacent signal transmission lines while signals transmitted by the port being output. The device has a high practical value in use.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A noise reduction device for ports of DSL (Digital Subscriber Line) filters comprising:
a circuit board disposed between a circuit board connection area and a connection end of a port of a DSL filter;
a plurality of signal transmission line sets arranged on the circuit board and each signal transmission line set having a first signal transmission line and a second signal transmission line, corresponding to each other while phase difference between signals transmitted by the first signal transmission line and the second signal transmission line of the signal transmission line set is 180 degrees;
wherein between two adjacent signal transmission line sets, a first cross part is formed between the first signal transmission line and the second signal transmission line of a first signal transmission line set so that the first signal transmission line of a second signal transmission line set that originally is adjacent to the second signal transmission line of the first signal transmission line set becomes to be adjacent to the first signal transmission line of the first signal transmission line set after the first cross part.

2. The device as claimed in claim 1, wherein a second cross part is formed on an output ends of the first signal transmission line and the second signal transmission line of the first signal transmission line set;
after the second cross part, the first signal transmission line of the second signal transmission line set is shifted to be adjacent to the second signal transmission line of the first signal transmission line set so that the first signal transmission line and the second signal transmission line of each signal transmission line set between the circuit board connection area and the connection end are arranged in the same order.

3. A method for reducing port noises of DSL (Digital Subscriber Line) filters comprising the steps of:
arranging a plurality of signal transmission line sets between a circuit board connection area and a connection end of a port of a DSL filter and each signal transmission line set having a first signal transmission line and a second signal transmission line corresponding to each other;
transmitting signals by the first signal transmission line and by the second signal transmission line of each signal transmission line set with a phase difference of 180 degrees; and
crossing a first signal transmission line and a second signal transmission line of a first signal transmission line set so that a first signal transmission of a second signal transmission line set that is initially adjacent to the second signal transmission line of the first signal transmission line set is changed to be adjacent to the first signal transmission line of the first signal transmission line set.

4. The method as claimed in claim 3, wherein after the step of crossing a first signal transmission line and a second signal transmission line of a first signal transmission line set so that a first signal transmission of a second signal transmission line set that is initially adjacent to the second signal transmission line of the first signal transmission line set is changed to be adjacent to the first signal transmission line of the first signal transmission line set, the method further includes a step of:
crossing the first signal transmission line and the second signal transmission line of the first signal transmission line set again near output ends of the first signal transmission line and the second signal transmission line of the first signal transmission line set so that the first signal transmission line of the second signal transmission line set that is adjacent to the first signal transmission line of the first signal transmission line set is changed to be adjacent to the second signal transmission line of the first signal transmission line set and the first signal transmission line and the second signal transmission line of each signal transmission line set between the circuit board connection area and the connection end are arranged in the same order.

5. A method for reducing port noises of DSL(Digital Subscriber Line) filters comprising the steps of:
arranging a plurality of signal transmission line sets at a DSL filter and each signal transmission line set having a first signal transmission line and a second signal transmission line corresponding to each other;
transmitting signals by the first signal transmission line and by the second signal transmission line of each signal transmission line set with a phase difference of 180 degrees; and
crossing a first signal transmission line and a second signal transmission line of a first signal transmission line set so that a first signal transmission line of a second signal transmission line set that is initially adjacent to the second signal transmission line of the first signal transmission line set is changed to be adjacent to the first signal transmission line of the first signal transmission line set.
